(19) United States
(12) Patent Application Publication
(10) Pub. No.: US 2011/0068734 A1
(43) Pub. Date: Mar. 24, 2011

(54) BATTERY MAINTENANCE KIT

(76) Inventor: John F. Waldron, Elgin, IL (US)

(21) Appl. No.: 12/562,480

(22) Filed: Sep. 18, 2009

(51) Int. Cl. H02J 7/00

(52) U.S. Cl. 320/107

(57) ABSTRACT

A battery maintenance kit for sealed batteries is disclosed that is useful for as servicing sealed 6 volt/12 volt lead acid batteries and optionally determining the state of charge of such a battery. In exemplary embodiment of the invention, the battery maintenance kit is configured as a universal kit for servicing sealed batteries used in a variety of 6 volt/12 volt DC vehicle applications, such as applications for automobiles and trucks, motorcycles, lawn tractors and all terrain vehicles (ATVs). For example, the battery maintenance kit may be equipped with a 6/12 volt DC compact battery charger with a quick disconnect harness. Various termination assemblies may be provided including battery clamps, a cigarette lighter adapter and ring terminals, which enable the battery charger to be used in various applications. The battery maintenance kit may also include a voltmeter, wrenches, a flashlight, battery side mount conversion terminals and a battery post cleaner. In accordance with an important aspect of the invention. The interior of the carrying case is formed with a dedicated compartment for each item in the kit that is segregated from all other compartments. The compartments for some items are form fitting compartments and are thus configured to the shape of the item to be carried. One or more studs is provided in one dedicated compartment for securely carrying the battery clamps. The carrying case allows all of the items to be carried securely in a closed carrying case and transported without movement in the carrying case.

### BACKGROUND OF THE INVENTION

1. Field of the Invention

The present invention relates to a battery maintenance kit and more particularly to a battery maintenance kit which includes a carrying case formed with a plurality of individualized form fitting compartments for carrying tools and devices associated with the maintenance of a vehicle battery, such as a 12 volt sealed lead acid battery.

2. Description of the Prior Art

Battery maintenance kits (also known as battery servicing kits) are known in the art. Examples of such battery maintenance kits are disclosed in U.S. Pat. Nos. 2,191,837; 2,205,495; 2,633,237; 2,646,873 and US Patent Application Publication No. US 2005/0070155 A1, all hereby incorporated by reference. U.S. Pat. Nos. 2,191,837; 2,205,495; 2,633,237; 2,646,873 relate to battery maintenance kits. The battery maintenance kits disclosed in the aforementioned patents are for serviceable wet cell lead acid vehicle batteries. Such lead acid batteries were formed with removable caps which allowed external access to each of the battery cells. The liquid electrolyte in such lead acid batteries was known to become depleted over time for various reasons and require replenishment with distilled water. The removable caps allowed the liquid electrolyte in each cell to be replenished and the condition of each battery cell to be tested by way of a hydrometer. Hydrometers were known to be used to measure the specific gravity of the electrolyte in a cell and provide an indication of the condition or state of charge of the cell based upon the specific gravity reading.

In general, the battery maintenance kits for use with the serviceable wet cell lead acid vehicle batteries described in the above mentioned patents included a carrying case for carrying distilled water and various devices required for servicing such serviceable wet cell lead acid vehicle batteries. For example, such battery maintenance kits were known to include hydrometer and battery filler. Such battery fillers are similar to a syringe and were used for withdrawing distilled water from the carrying case and discharging it into individual battery cells having low liquid electrolyte levels.

The carrying case was formed as a box open on top with a handle. The box was formed with one dedicated compartment and one or more non-dedicated compartments. The dedicated compartment was closed on top with a cover for carrying distilled water. U.S. Pat. Nos. 2,191,837; 2,205,495 and 2,646,873 disclose two apertures were formed in the cover. These apertures provided a dual function. First the apertures provided access to the distilled water in the dedicated compartment. Second, the apertures were used for carrying the battery filler and the hydrometer. More particularly, both the hydrometer and the battery filler are comprised of elongated tubes with a rubber bulb at one end. The apertures in the cover were configured to receive these devices in a vertical position, immersed in the distilled water.

U.S. Pat. Nos. 2,191,837 and 2,205,495 disclose open top non-dedicated compartments formed in the carrying case. These non-dedicated compartments were for loosely carrying tools involved in servicing such serviceable wet cell lead acid vehicle batteries, such as wrenches, battery post cleaners and meters for measuring the battery voltage, such as a voltmeter or multi-meter. Unfortunately, such meters were loosely carried in the non-dedicated compartments and were known to become damaged during transport. As such, battery maintenance kits were formed with a dedicated compartment for a meter, for example, as disclosed in U.S. Pat. No. 2,633,237. As disclosed therein, the dedicated meter compartment was formed with a relatively complex mechanical arrangement for releasably securing the meter within carrying case. The carrying case included a cover, apportion of which is hinged for providing access to the meter within the carrying case. The carrying case was also formed with an additional non-dedicated compartment for loosely carrying tools. An aperture of sufficient size for a man's hand was formed in a sidewall of the carrying case to provide access to the non-dedicated tool compartment.

Even though, battery maintenance kit disclosed in '237 patent provided protection to the meter in the carrying case, there were other problems with such a battery maintenance kit. First, the non-dedicated tool compartment with a sidewall access allowed tools to be dropped and lost. Second, the relatively complex mechanical arrangement for releasably securing the meter was cumbersome to use and mechanically complex, thus increasing the cost of such maintenance kits. Third, most modern vehicles are provided with lead acid batteries with newer sealed battery cells, so called sealed batteries, and are therefore not serviceable. As such, the battery maintenance kits described above are not completely useful with the newer sealed batteries.

As such, battery maintenance kits for newer batteries with sealed cells have been developed. An example of such a battery maintenance kit is disclosed in German published patent application publication no. DE 102006038048 A1, published Feb. 21, 2008. The battery maintenance kit disclosed in the German publication includes sensors for monitoring the voltage and temperature of a battery. The battery maintenance kit further includes an electronic circuit for processing the signals from the sensors. A Bluetooth device is included in the kit for receiving the signals from the electronic circuit and converting those signals to radio signals to enable the sensor signals to be displayed on a personal digital assistant (PDA).

Even though, the battery maintenance kit disclosed in the German publication is useful with newer sealed batteries, it is only useful for determining the state of charge of the battery. That kit is not otherwise useful in performing maintenance on the battery. For example, the battery terminals on sealed batteries are known to oxidize and corrode over time. In addition, when the charge on such sealed batteries is relatively low, vehicles with such sealed batteries are known to require jump starting.

Thus there is a need for a battery maintenance kit for newer sealed batteries that solves the problems in the prior art. Specifically there is a need for a battery kit which is useful in servicing sealed batteries as well as determining the state of charge of such batteries. There is also a need to provide a battery maintenance kit which overcomes the problems associated with battery maintenance kits for serviceable wet cell lead acid vehicle batteries.

### SUMMARY OF THE INVENTION

The present invention relates to a battery maintenance kit for servicing sealed 6 volt/12 volt lead acid batteries that is useful for servicing a 6 volt/12 volt sealed lead acid battery and optionally determining the state of charge of such a battery. In exemplary embodiment of the invention, the battery maintenance kit is configured as a universal kit for servicing sealed batteries used in a variety of 6 volt DC/12 volt DC vehicle applications, such as applications for automobiles and trucks, motorcycles, lawn tractors and all terrain vehicles (ATVs). For example, the battery maintenance kit may be equipped with a 6/12 volt DC compact battery charger with a quick disconnect harness. Various termination assemblies may be provided including battery clamps, a cigarette lighter adapter and ring terminals, which enable the battery charger to be used in various applications. The battery maintenance kit may also include a voltmeter, wrenches, a flashlight, battery side mount conversion terminals and a battery post cleaner. In accordance with an important aspect of the invention. The interior of the carrying case is formed with a dedicated compartment for each item in the kit that is segregated from all other compartments. The compartments for some items are form fitting compartments and are thus configured to the shape of the item to be carried. One or more studs is provided in one dedicated compartment for securely carrying the battery clamps. The carrying case allows all of the items to be carried securely in a closed carrying case and transported without movement in the carrying case.

### DESCRIPTION OF THE DRAWING

These and other advantages of the present invention will be readily understood with reference to the following specification and attached drawing wherein:

FIG. 1 is an isometric view of an exemplary embodiment of the battery maintenance kit in accordance with the present invention, shown with the carrying case open and an exemplary set of items installed in the carrying case.

FIG. 2 is similar to FIG. 1 but with all of the items removed from the carrying case.

FIG. 3 is an isometric view of an exemplary embodiment of an alternate embodiment of the battery maintenance kit in accordance with the present invention, shown with the carrying case open and an exemplary set of items installed in the carrying case.

### DETAILED DESCRIPTION

The present invention relates to a battery maintenance kit for servicing sealed batteries that is useful for servicing a 6 volt/12 volt sealed lead acid battery and optionally determining the state of charge of such a battery. In exemplary embodiment of the invention, the battery maintenance kit is configured as a universal kit for servicing sealed batteries used in a variety of 6 volt/12 volt DC vehicle applications, such as applications for automobiles and trucks, motorcycles, lawn tractors and all terrain vehicles (ATVs). For example, the battery maintenance kit may be equipped with a 6/12 volt DC compact battery charger with a quick disconnect harness. Various termination assemblies may be provided including battery clamps, a cigarette lighter adapter and ring terminals, which enable the battery charger to be used in various applications. The battery maintenance kit may also include a voltmeter, wrenches, a flashlight, battery side mount conversion terminals and a battery post cleaner. In accordance with an important aspect of the invention. The interior of the carrying case is formed with a dedicated compartment for each item in the kit that is segregated from all other compartments. The compartments for some items are form fitting compartments and are thus configured to the shape of the item to be carried. One or more studs is provided in one dedicated compartment for securely carrying the battery clamps. The carrying case allows all of the items to be carried securely in a closed carrying case and transported without movement in the carrying case.

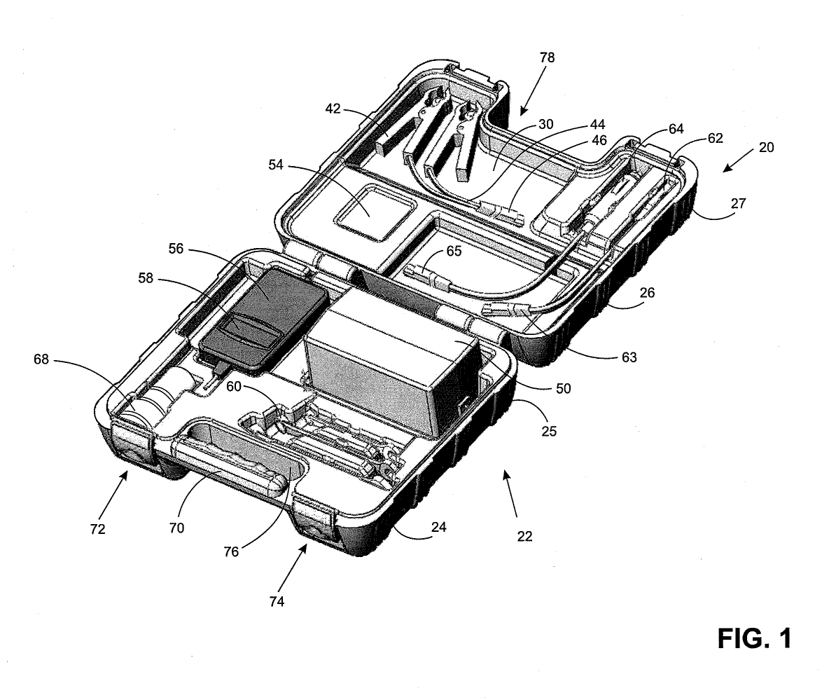

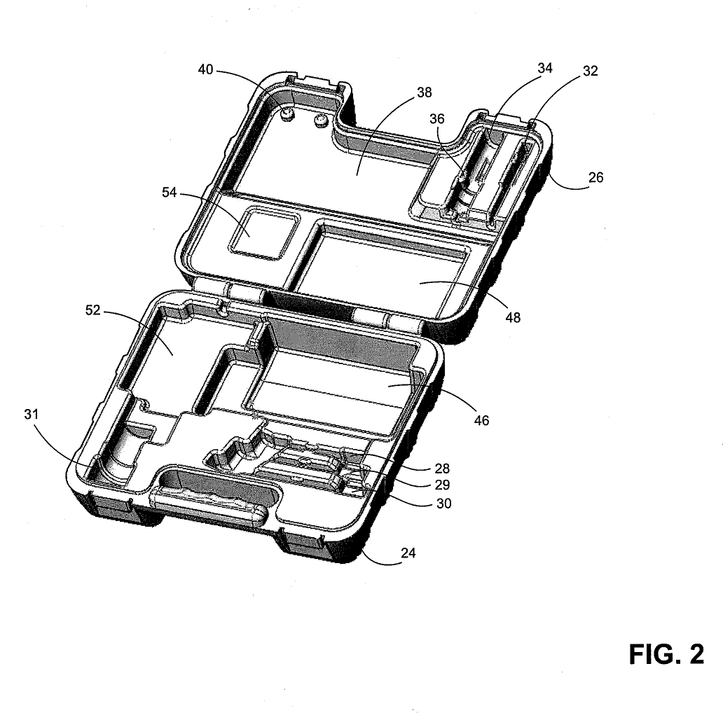

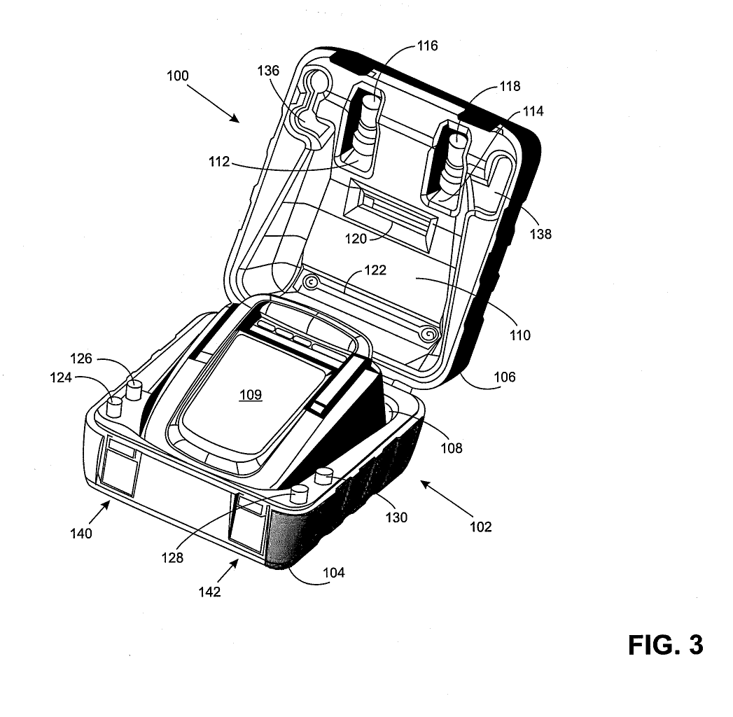

FIGS. 1 and 2 illustrate a first exemplary embodiment of the battery maintenance kit in accordance with the present invention. FIG. 3 illustrates a second exemplary embodiment of the invention. Both embodiments are illustrated and described below with an exemplary set of items. It is understood that more or fewer items can be included in the battery maintenance kit and still fall within the scope of the present invention.

Referring first to FIGS. 1 and 2, an exemplary battery maintenance kit is illustrated and generally identified with the reference numeral 20. As shown, the battery maintenance kit includes a two piece carrying case, generally identified with the reference numeral 22 having a base 24 and a cover 26. The cover 26 is formed with the same general shape as the base 24 to secure all items in the carrying case 22 when the cover is in a closed position.

In the exemplary embodiment shown, the carrying case 22 is configured to carry items in both the cover 26 as well as the base 24. In accordance with an important aspect of the invention, the carrying case 22 is configured with a plurality dedicated compartments. Specifically, a dedicated compartment may be provided for each item or each type of item in the carrying case 22. All of the compartments are segregated from each other. The compartments are formed as recessed volumes in the carrying case 22. In order to make the battery maintenance kit relatively compact, in one exemplary embodiment as illustrated in FIGS. 1 and 2, compartments are formed in both the base 24 and the cover 26. In other embodiments (not shown), compartments may be formed in one or the other of the base 24 or the cover 26.

Various types of compartments may be formed in the base 24 and cover 26 depending on the item to be carried. Both the base 24 and the cover 26 may be formed in a generally rectangular or square shape and include sidewalls, generally identified with the reference numerals 25 and 27, respectively, forming pan like devices. The base and 24 and the cover 26 are formed with complementary shapes so that when the cover is in a closed position the interior of the carrying case 22 is inaccessible.

In an exemplary embodiment, various types of compartments are formed in both the base 24 and the cover 26. These compartments may be recessed with respect to a plane (not shown), generally perpendicular to the sidewalls 25 and 27 and juxtaposed adjacent thereto. For example, a first type of compartment, identified with the reference numerals 28, 29, 30, 31, 32 and 34 (FIG. 2) may be configured to be form fitting and configured to the shape of the item to be carried and held in place by friction. For example, the carrying case 22 may be molded from a plastic material and configured with tabs, generally identified with the reference numeral 36, that project into the compartment and enable items to snap in and snap out. The first type of compartment defines an accessory compartment.

A second type of compartment, generally identified with the reference numeral 38, may be provided with one or more studs 40. The studs 40 are used to enable battery clamps 42 (FIG. 1) to be secured thereto. The open space in the compartment 38 is for carrying a wire harness 44 that is tethered to a quick connect connector 46 on one end and connected to the battery clamps 42 on the other end. The quick connect connector 46 is configured to mate with a complementary connector (not shown) tethered to a battery charger 50, as described below The second type of compartment defines a battery clamp compartment. The second type of compartment defines a battery clamp compartment.

A third type of compartment may be formed from cooperating complementary recesses 46 and 48 in both the base 24 and the cover 26, respectively. The recess 46 in the base 24 is for receiving a 6 volt/12 volt DC battery charger 50 (FIG. 1), for example, a Schumacher Electric, Model No. SC 200A or other battery charger. The recess 48 in the cover 26 provides clearance in the cover 26 to enable it to be fully closed. The recesses 46 and 48 have generally equal areas and may be configured with the same or different depths. Depending on the actual thickness of the charger 50 and the desired thickness of the carrying case 22, the recess 48 may not be required. The third type of compartment defines a charger compartment.

A fourth type of compartment may be formed from a compartment formed from cooperating recesses 52 in the base 24 and a recess 54 in the cover 26. These recesses 52 and 54 may be used to carry a meter 56 (FIG. 1) with a protruding knob 58. The area of the recess 52 (FIG. 1) is sized to receive to receive the meter 56, for example, a voltmeter, such as a Schumacher Electric Model BT-50 or other voltmeter or other meter, such as a multi-meter. Depending on the thickness meter used and whether the meter has any protruding knobs, the recess 54 may not be required. If the recess 54 is required, the area of the recess 54 may be selected to provide clearance for the knob 58 or clearance for the entire meter 56. The fourth type of compartment defines a meter compartment.

As mentioned above, in the exemplary embodiment shown in FIGS. 1 and 2, the battery maintenance kit 20 may include various accessory compartments, for example, the compartments 28, 29, 30, 31, 32 and 34. One or more compartments 28, 29 and 30 can be used to carry various non-adjustable open end and/or box wrenches, generally identified with the reference numeral 60. The wrenches 60 may be coated with a dielectric material, such as PVC, and include sizes useful in servicing sealed lead acid batteries. For example, the wrenches 60 may be sized to enable loosening and tightening battery post clamps used to secure a battery cable to a battery post. Alternatively, a single compartment may be provided for carrying an adjustable wrench or pliers.

The compartments 32 and 34 may be used for carrying accessories for the battery charger 50. In particular, the exemplary battery charger 50 includes multiple battery termination accessories each tethered to a quick connect connector 46, as described above.

For example, in addition to the battery clamps 42, the compartment 32 (FIG. 2) may be for a ring connector accessory 62 (FIG. 1) for the battery charger 50, used to attach one or more ring or equivalent connectors to a vehicle battery terminal. This accessory is known to be used to permanently connect the one or more ring connectors to batteries in vehicles in which the batteries are in hard to access locations. Once the one or more ring connectors are permanently connected to the battery terminals or alternatively to one battery terminal and system ground, the battery can easily be charged by connecting the quick connect connector 63 connected to the one or more ring terminals to a mating quick connect mating connector (not shown) attached to the battery charger 50.

The compartment 34 (FIG. 2) may be used to carry a cigarette lighter adapter accessory 64. The cigarette lighter adapter 64 is also connected to a wire harness and a quick connect connector 65. The cigarette lighter accessory allows a battery to be charged by the battery charger 50 by way of a cigarette lighter receptacle, available in most automobiles and trucks. In this application, the battery charger 50 is plugged into a conventional AC receptacle, for example a 120 volt AC receptacle. The cigarette lighter accessory 64 is connected to the battery charger 50 by way of the mating quick connect connectors. The battery is then charged by pumping charging current from the cigarette lighter receptacle to the battery. The quick connect connector 65 for the cigarette lighter adapter accessory 64 as well as the quick connect connector 63 for the ring connector accessory 62 and the respective wire harnesses may be stored in the recess 48, as generally shown in FIGS. 1 and 2.

The compartment 31 (FIG. 2) may be used to carry a conventional battery post cleaner 68. Such battery post cleaners are extremely well known in the art and include a generally cylindrical housing for carrying a circularly wire brush that is configured to receive a conventional automobile or truck battery post. The wire brush is used to remove corrosion from the battery post to provide a good electrical connection to a battery post clamp on a battery cable.

The carrying case 22 may be formed with a handle 70 and one or more latch assemblies 72 and 74. An exemplary handle 70 is illustrated in FIGS. 1 and 2. As shown an elongated slot 76 is formed along a front edge of the base 24, opposite a hinge 78 that rotatably connects the cover 26 to the base 24. The slot defines the handle 70 as shown. A complementary notch 78 is formed in the cover 26 in order to provide access to the handle 70 when the cover 26 is closed.

Various conventional means can be used to secure the cover 26 to the base 24 in a closed position. As shown, one or more conventional latch assemblies, generally identified with the reference numerals 72 and 74 may be used. All conventional latch assemblies are considered to be within the scope of the invention.

As mentioned above, the embodiment illustrated in FIGS. 1 and 2 is merely exemplary. Alternate embodiments with more or fewer compartments are considered to be within the scope of the invention. For example, additional accessories may be included. For example a flashlight (not shown) and/or safety goggles (not shown) may be included. Fewer wrenches 28, 29 and 30 may be included.

An alternate embodiment of the invention is illustrated in FIG. 3. This embodiment is generally identified with the reference number 100. This embodiment is contemplated for use with relatively larger size battery chargers, such as a DieHard® Model No. 71227 battery charger. The battery charger kit 100 includes a carrying case, generally identified with the reference numeral 102 which includes a base 104 and a hinged cover 106. A number of dedicated compartments are formed in the carrying case 102.

A first type of compartment is a dedicated battery charger compartment. The battery charger compartment may be formed as a recessed volume 108 in the base 104 which receives the battery charger 109 and a corresponding recessed volume 110 formed in the cover 106. The recessed volume or compartment 110 may be formed with a profile, such as a sloped profile, to match the vertical profile of the battery charger. Additional compartments may be provided for accessories. For example one or more recessed volumes 112 and 114 may be provided in the cover 106 to provide compartments for one or more battery post cleaners 116 and 118. These compartments 112 and 114 may be countersunk relative to the compartment 110. One or more additional countersunk compartments 120 and 122 may countersunk in the compartment 110 in the cover 106. These compartments 120 and 122 may be formed as snap in compartments and used to carry tools, such as wrenches.

One or more complementary compartments may be provided for receiving battery side terminal conversion terminals. The battery side mount conversion terminals are conventional and include a post on one end for connecting to a battery clamp and threaded studs on the other end for screwing into a battery side mount terminal. Four such battery side mount conversion terminals are shown and identified with the reference numerals 124, 126, 128 and 130. However, only one or more of such battery side mount conversion terminals are required. These battery side mount conversion terminals 124, 126, 128 and 130 are carried in compartments (not shown) formed in the base. Clearance for these battery side mount conversion terminals 124, 126, 128 and 130 may be provided by complementary compartments 136 and 138 formed in the cover 106.

The battery maintenance kit 100 may include fewer accessories than shown in FIG. 3. The battery maintenance kit 100 may include additional accessories and compartments as described above in connection with FIGS. 1 and 2. The carrying case 102 may also be configured with one or more conventional latch assemblies, generally identified with the reference numerals 140 and 142 and a handle (not shown).

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A battery maintenance kit comprising:
a carrying case having a base and a cover rotatably attached to said base, a plurality of different types of dedicated compartments formed in said base including a battery charger compartment for receiving a battery charger and at least one form fitting accessory compartment, said accessory compartment formed to the general shape to be carried;
a battery charger configured to be received in said battery charger compartment; and
at least one accessory configured to be received in said form fitting accessory compartment.
